(19) United States
(12) Patent Application Publication
(10) Pub. No.: US 2021/0388731 A1
(43) Pub. Date: Dec. 16, 2021

(54) TURBINE STATOR BLADE

(71) Applicant: TOSHIBA ENERGY SYSTEMS & SOLUTIONS CORPORATION, Kawasaki-shi (JP)

(72) Inventors: Norikazu TAKAGI, Kawasaki (JP); Tsuguhisa TASHIMA, Yokohama (JP); Daisuke NOMURA, Kawasaki (JP); Yoshifumi IWASAKI, Yokohama (JP); Shogo IWAI, Tokyo (JP); Takahiro ONO, Tokyo (JP)

(73) Assignee: TOSHIBA ENERGY SYSTEMS & SOLUTIONS CORPORATION, Kawasaki-shi (JP)

(21) Appl. No.: 17/343,206

(22) Filed: Jun. 9, 2021

(30) Foreign Application Priority Data
Jun. 16, 2020 (JP) 2020-103654

(51) Int. Cl. F01D 11/00; F01D 9/04

(52) U.S. Cl. CPC F01D 11/006; F05D 2240/12; F05D 2220/32; F01D 9/041

(57) ABSTRACT

According to an embodiment, a turbine stator blade disposed in a working fluid flow path in a casing of a gas turbine, includes: a blade effective part disposed in the working fluid flow path; an outer circumferential sidewall having a plate-shaped part that is connected to a radially outer end portion of the blade effective part, and hooks each extending radially outward and circumferentially from the plate-shaped part and having a tip engaged with the casing; and an inner circumferential sidewall connected to a radially inner end portion of the blade effective part. At least one slit is formed at the rear hook or front hook to divide the hook in a circumferential direction, and the hook has a seal member to seal the slit.

### CROSS-REFERENCE TO RELATED APPLICATION

This application is based upon and claims the benefit of priority from Japanese Patent Application No.2020-103654 filed on Jun. 16, 2020, the entire content of which is incorporated herein by reference.

### FIELD

Embodiments of the present invention relate to a turbine stator blade used for a gas turbine.

### BACKGROUND

In recent gas turbines, due to high temperature of working fluid, cooling medium is supplied to hollow portions of rotor blades and stator blades, which have a hollow cooling structure fabricated by precision casting. This prevents temperature rise due to heat transfer from the working fluid.

In the case of stator blades of a gas turbine, the stator blades, which are each formed by one or a plurality of blade effective parts integrated by being sandwiched between an outer circumferential sidewall at radial outside and an inner circumferential sidewall at radial inside, are arranged circumferentially. The stator blade is supported by a casing from the radial outside by a front hook and rear hook protruding radially outward at the outer circumferential sidewall and engaged with the casing.

The cooling medium is introduced from the casing side to the blade effective part through the outer circumferential sidewall. Therefore, a cooling medium space is formed circumferentially between the front hook and rear hook, which serves as a flow path connecting a supply flow path from the casing to the blade effective part of each stator blade.

Here, among gas turbines, a CO₂ turbine requires the same cooling structure as a conventional gas turbines because operating temperature is as high as that of the conventional gas turbine, and the rotor blades and stator blades have hollow structure as described above.

On the other hand, an operating pressure of the CO₂ turbine is as high as that of a steam turbine, and pressure difference generated at the rotor blades and stator blades, that is, a pressure difference between the cooling medium and the working fluid, or pressure difference between pressure in front and pressure behind the rotor blade, is as much as ten times higher than those of the conventional gas turbine. In the case of the steam turbine, for example, the rotor blades and stator blades are thick-walled and solid and are designed to withstand large pressure differences, but the CO₂ turbine cannot take the same approach as the steam turbine because the rotor blades and stator blades are required to have the cooling structure as described above.

Thus, the stator blade of the CO₂ turbine is used under high-temperature and high-pressure conditions that are more severe in strength than those of the conventional gas turbine.

The stator blade is attached to the casing with hooks. In the stator blade of the CO₂ turbine, wall-thicknesses of a portion of the outer circumferential sidewall, which supports the blade effective part at a radially outer end portion of the blade effective part, and wall-thicknesses of the hook, which extends radially outward at the outer circumferential sidewall and is coupled to a casing hook, are thicker compared to the conventional gas turbine, because they are used under high-pressure conditions as described above. As a result, when comparing stiffness of the blade effective part with that of the outer circumferential sidewall, the stiffness of the outer circumferential sidewall is relatively higher.

In the outer circumferential sidewall, large metal temperature difference is produced between a portion that is exposed to the high-temperature working fluid during operation and a portion such as hook portion that is exposed to the low-temperature cooling medium. Therefore, there has been a problem that when thermally deformed, thermal stress at a root of the blade effective part, that is, a portion attached to the outer circumferential sidewall, becomes high, leading to damage. In solving this problem, to reduce deterioration of turbine performance is another problem

### BRIEF DESCRIPTION OF THE DRAWINGS

FIG. 1 is a partial sectional view along a shaft center axis of a gas turbine illustrating an attached state of a turbine stator blade according to a first embodiment.

FIG. 2 is a plan view of the turbine stator blade according to the first embodiment, viewed from radial outside.

FIG. 3 is a sectional arrow view illustrating the turbine stator blade according to the first embodiment, taken along a line III-III in FIG. 2.

FIG. 4 is a front arrow view illustrating the turbine stator blade according to the first embodiment, taken along a line IV-IV in FIG. 2.

FIG. 5 is a perspective view schematically illustrating an example of temperature distribution for explaining an effect of the turbine stator blade according to the first embodiment.

FIG. 6 is a perspective view schematically illustrating deformation due to the example of the temperature distribution for explaining the effect of the turbine stator blade according to the first embodiment.

FIG. 7 is a perspective view schematically illustrating an example of a deformed state of an outer circumferential sidewall with no slit formed for explaining the effect of the turbine stator blade according to the first embodiment.

FIG. 8 is a perspective view schematically illustrating an example of a deformed state of the outer circumferential sidewall with slits formed for explaining the effect of the turbine stator blade according to the first embodiment.

FIG. 9 is a plan view of a turbine stator blade according to a second embodiment, viewed from the radial outside.

FIG. 10 is a sectional arrow view illustrating the turbine stator blade according to the second embodiment, taken along a line X-X in FIG. 9.

FIG. 11 is a front arrow view illustrating the turbine stator blade according to the second embodiment, taken along a line XI-XI in FIG. 9.

### DETAILED DESCRIPTION

An object of this embodiment is to ensure soundness of a turbine stator blade without causing degradation of turbine performance.

According to an aspect of the present invention, there is provided a turbine stator blade disposed in a working fluid flow path in a casing of a gas turbine, the turbine stator blade comprising: a blade effective part disposed in the working fluid flow path; an outer circumferential sidewall including a plate-shaped part that is connected to a radially outer end portion of the blade effective part, and hooks each extending radially outward and circumferentially from the plate-shaped part and having a tip engaged with the casing; and an inner circumferential sidewall connected to a radially inner end portion of the blade effective part; wherein at least one slit is formed at the hook to divide the hook in a circumferential direction, and the hook has a seal member to seal the slit.

Hereinafter, a turbine stator blade according to embodiments of the present invention will be explained with reference to the drawings. Here, substantially the same or similar components are denoted by the same reference signs, and a redundant description is sometimes omitted.

### First Embodiment

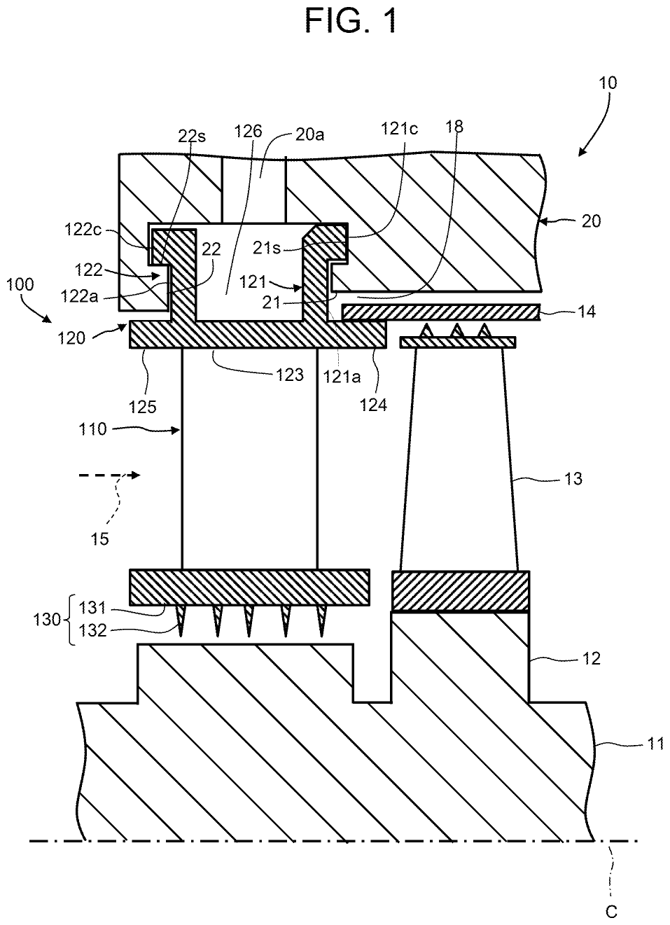

FIG. 1 is a partial sectional view along a shaft center axis C of a gas turbine 10 illustrating an attached state of a turbine stator blade 100 according to a first embodiment. In the following, a configuration around the turbine stator blade 100 in the gas turbine 10 will be mainly explained.

In the following, a direction parallel to the shaft center axis C, which is a rotation axis of a rotor shaft 11, is referred to as an axial direction, and a direction away from the shaft center axis C is referred to as a radial direction. A direction toward or near the rotor shaft 11 in the radial direction is referred to as a radial inside, and a direction away from or farther from the rotor shaft 11 in the radial direction is referred to as a radial outside.

An annular working fluid flow path 15 is formed on the radial outside of the rotor shaft 11 and on the radial inside of a casing 20 of the gas turbine 10, through which a working fluid, which is generated by a non-illustrated combustor and flowing into the gas turbine 10, is flowing. Flow direction of the working fluid in the working fluid flow path 15 is from a left side to a right side in FIG. 1. For convenience of explanation, an upstream side of the working fluid flow may be sometimes referred to as front side and a downstream side as rear side.

Rotor discs 12 are formed on the rotor shaft 11, extend radially outward and are disposed with axial intervals therebetween. A plurality of rotor blades 13 are attached to each of the rotor discs circumferentially and form a rotor blade cascade. Shroud segments 14 are provided circumferentially via gaps at the radial outside of the rotor blades 13 to allow cooling medium to pass between the shroud segments 14 and the casing 20 and to prevent the high-temperature working fluid in the working fluid flow path 15 from touching the casing 20.

Immediately upstream of the rotor blades 13, a plurality of turbine stator blades 100 are disposed circumferentially to form a stator blade cascade. Each turbine stage is formed by each stator blade cascade and its immediately downstream rotor blade cascade. In FIG. 1, only one turbine stage is illustrated.

Each turbine stator blade 100 has a blade effective part 110 that is disposed in the working fluid flow path, an outer circumferential sidewall 120 that is a portion disposed radially outside the blade effective part 110, and an inner circumferential sidewall 130 that is a portion disposed radially inside the blade effective part 110. One or a plurality of blade effective parts 110 are provided between one outer circumferential sidewall 120 and the corresponding inner circumferential sidewall 130. The inner circumferential sidewall 130 has a plate-shaped part 131 that extends axially and extends circumferentially, and a plurality of labyrinth teeth 132 that are formed with axial intervals therebetween to extend circumferentially on a radially inner surface of the plate-shaped part 131. The plurality of labyrinth teeth 132 form a labyrinth with a surface of the rotor shaft 11.

The turbine stator blade 100 is supported by the casing 20 at the outer circumferential sidewall 120. The details are described below.

The outer circumferential sidewall 120 has a plate-shaped part 123, a rear hook 121, and a front hook 122. The plate-shaped part 123 is a portion that is connected to a radially end portion of the blade effective part 110. The rear hook 121 and front hook 122 are formed to extend radially outward on rear and front portions of a radially outer surface of the plate-shaped part 123, respectively. The rear hook 121 and front hook 122 are hereinafter collectively referred to as hooks.

The rear hook 121 has a rear hook wall part 121a that is a portion extending radially outward, and a rear hook protruding part 121c that is formed to protrude rearward from a radially outer end portion of the rear hook wall part 121a.

The front hook 122 has a front hook wall part 122a that is a portion extending radially outward, and a front hook protruding part 122c that is formed to protrude forward from a radially outer end portion of the front hook wall part 122a.

On the other hand, the casing 20 has casing rear hooks 21 and casing front hooks 22 formed circumferentially. The casing rear hook 21 is engageable with the rear hook protruding part 121c of the rear hook 121 radially inside and outside each other. The casing front hook 22 is engageable with the front hook protruding part 122c of the front hook 122 radially inside and outside each other. As a result, the turbine stator blade 100 is attached to the casing 20 and supported by the casing 20.

The rear hook 121 and the front hook 122 of the outer circumferential sidewall 120 form a cooling medium space 126, in a part between the rear hook 121 and front hook 122, which introduces the cooling medium leading to an inside of the blade effective part 110. As a result, the cooling medium space 126 is formed throughout whole circumferences. At least one cooling medium flow path 20a is formed at the casing 20 to lead the cooling medium to this cooling medium space 126.

The first reason for providing the cooling medium space 126 is to reduce thermal effect on the casing 20. That is, the blade effective part 110 of the turbine stator blade 100 is exposed to the high-temperature working fluid. A radially inner surface of the outer circumferential sidewall 120 is in contact with the working fluid, and with the addition of heat conduction from the blade effective part 110, it becomes in a high-temperature state. Although the outer circumferential sidewall 120 is engaged with the casing 20, a material of the casing 20 is generally not such material as those capable of enduring high temperature like a material of the turbine stator blade 100. Therefore, it is necessary to keep the temperature of the casing 20 within an appropriate temperature range.

The second reason for providing the cooling medium space 126 is to secure a supply flow path of the cooling medium to the blade effective part 110. In many gas turbines, the blade effective parts 110 are each hollow and have a cooling medium flow path formed thereinside. This is because a circumferential annular flow path is necessary to supply the cooling medium to each of the turbine stator blades 100 arranged circumferentially.

On front and rear side of the plate-shaped part 123 of the outer circumferential sidewall 120, a rear protruding part 124 is formed as a portion on a rear downstream end side from a connecting portion of the plate-shaped part 123 and the rear hook 121, and a front protruding part 125 is formed as a portion on a front (upstream side) upstream end side a connecting portion of the plate-shaped part 123 and the front hook 122.

The outer circumferential sidewall 120 is formed by integrally casting the plate-shaped part 123, the rear protruding part 124, the front protruding part 125, the rear hook 121, and the front hook 122, for example, and partially finished by machining.

A radially outer surface of the rear protruding part 124 is in close contact with a radially inner surface of the shroud segment 14 disposed on the radial outside of the rotor blade 13, to form a seal portion between an intermediate chamber 18, which is formed between the shroud segment 14 and the casing 20, and the working fluid flow path 15.

In an operating state of the gas turbine 10, the rear hook 121 of the outer circumferential sidewall 120 and the casing rear hook 21 form a seal portion by close-contact between a rear side surface of the rear hook protruding part 121c of the rear hook 121 and a rear sealing surface 21s that is a rear side surface on the radial outside of the casing rear hook 21. This is mainly because the turbine stator blade 100 is pushed to rear (downstream) side due to pressure difference of the working fluid in front and behind the turbine stator blade 100. This seal portion functions as a seal portion between the cooling medium space 126 and the intermediate chamber 18.

In the operating state of the gas turbine 10, the front hook 122 of the outer circumferential sidewall 120 and the casing front hook 22 form a seal portion by close-contact between a radially inner surface of the front hook protruding part 122c of the front hook 122 and a front sealing surface 22s that is a radially outer surface of the casing front hook 22. This is mainly because the outer circumferential sidewall 120 is pushed to the radial inside due to a differential pressure between the cooling medium in the cooling medium space 126 and the working fluid in the working fluid flow path 15. This seal portion functions as a seal portion between the cooling medium space 126 and the working fluid flow path 15.

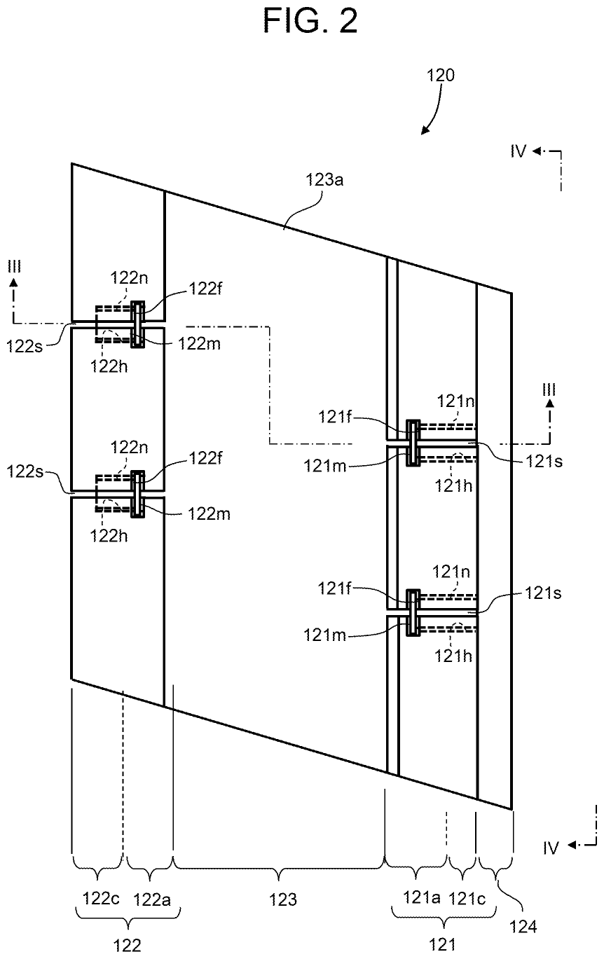

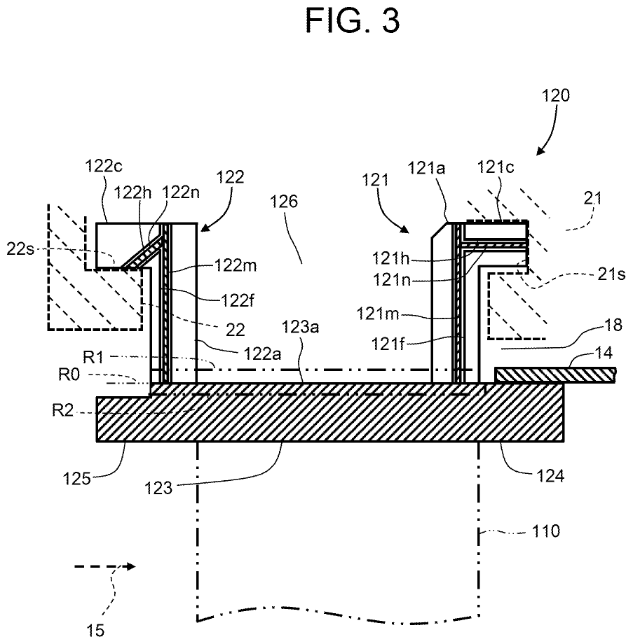

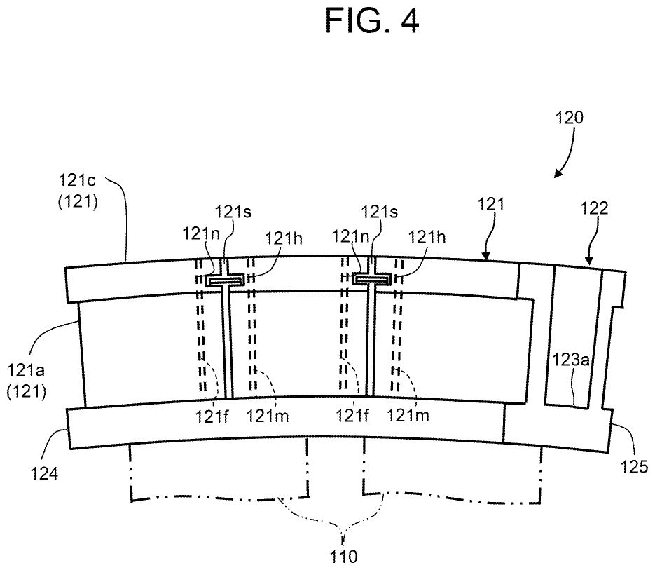

FIG. 2 is a plan view of the turbine stator blade according to the first embodiment, viewed from radial outside, FIG. 3 is a sectional arrow view taken along a line III-III in FIG. 2, and FIG. 4 is a front arrow view taken along a line IV-IV in FIG. 2. A configuration of the outer circumferential sidewall 120, which is a characteristic portion of the turbine stator blade 100 according to the present embodiment, will be mainly explained below using FIG. 2 to FIG. 4.

The outer circumferential sidewall 120 has the aforementioned rear hook 121, front hook 122, and plate-shaped part 123. The plate-shaped part 123 is a connection portion with a radially outer end portion of the blade effective part 110 and extends circumferentially along a concentric circle with the rotor shaft 11 (FIG. 1). The front hook 122 and rear hook 121 each extend radially outward from the radially outer surface of the plate-shaped part 123 and extend circumferentially.

As illustrated in FIG. 3, the rear hook 121 has the rear hook wall part 121a that is the portion extending radially outward, and the rear hook protruding part 121c formed to protrude rearward from the radially outer end portion of the rear hook wall part 121a. As mentioned above, the rear side surface of the rear hook protruding part 121c is in close contact with the rear sealing surface 21s of the casing rear hook 21 to form the seal portion between the intermediate chamber 18 and the working fluid flow path 15.

The front hook 122 has the front hook wall part 122a that is the portion extending radially outward, and the front hook protruding part 122c formed to protrude forward from the radially outer end portion of the front hook wall part 122a described above. As mentioned above, the radially inner surface of the front hook protruding part 122c is in close contact with the front sealing surface 22s (FIG. 1) of the casing front hook 22 to form the seal portion between the cooling medium space 126 and the working fluid flow path 15 (FIG. 1).

FIG. 3 illustrates a cross-section at a portion where these seal portions are missing due to formation of slits, which will be described later, and seal members described later are compensating for the defect in the seal portions.

As illustrated in FIG. 2 and FIG. 4, a plurality of slits, described below, are formed at the outer circumferential sidewall 120, and in each of the slits, the seal members, described below, are attached to ensure a sealing function of the seal portion described above. FIG. 3 illustrates the cross-section along the axial direction at the seal portion as described above. That is, area, where the slits are formed, are illustrated by unhatched area.

In the following, the case when there are rear hook slits 121s formed at the rear hook 121 and front hook slits 122s formed at the front hook as the formed slits is illustrated as an example, but only one of the slits may be formed such as only the rear hook slits 121s formed at the rear hook 121, for example, as long as the soundness of the turbine stator blade 100 can be ensured as described later. That is, the slits may be formed at a part of the hook or the entire hook.

The following describes the case of the rear hook 121 and the case of the front hook 122, in turn.

As illustrated in FIG. 2 and FIG. 4, two rear hook slits 121s as the slits are formed at the rear hook 121 in the axial direction. The number of rear hook slits 121s is not limited to two, but can be one, three, or more.

As illustrated in FIG. 4, the rear hook slits 121s are formed along the axial direction to extend radially, but the plurality of rear hook slits 121s in one turbine stator blade 100 need not all be formed radially, and for example, may be formed parallel to each other and their centers may locate radially.

A depth in the radial direction of each rear hook slit 121s reaches a radial position RO that is the same radial position as a plate-shaped part radially outer surface 123a of the plate-shaped part 123, as illustrated in FIG. 3.

As illustrated in FIG. 3, regarding the depth in the radial direction of the rear hook slit 121s, a radially innermost portion of the rear hook slit 121s may be, for example, at a radial position R1 that is at the radial outside than the radially outer surface of the plate-shaped part 123, as long as an effect of reducing stiffness of the outer circumferential sidewall 120 described below is obtained. Alternatively, the radially innermost portion of the rear hook slit 121s may be, for example, at a radial position R2 that is at the radial inside than the radially outer surface of the plate-shaped part 123, to further reduce the stiffness.

Here, when the radially innermost portion of the rear hook slit 121s is set at the radial inside than the radially outer surface of the plate-shaped part 123, area forming the rear hook slit 121s up to the radial position R2 should not reach the rear protruding part 124 of the plate-shaped part 123, because if the radially outer surface of the rear protruding part 124, which forms the seal portion with the shroud segment 14, is missed, the intermediate chamber 18 will be connected to a downstream portion of the blade effective part of the working fluid flow path 15.

Next, regarding the front hook 122, similarly, two front hook slits 122s as the slits are formed in the axial direction, as illustrated in FIG. 2. A depth in the radial direction of each front hook slit 122s reaches the same radial position RO as the radially outer surface of the plate-shaped part 123, as illustrated in FIG. 3. The number and depth of front hook slits 122s are the same as those of the rear hook slits 121s formed at the rear hook 121 described above.

The rear hook slit 121s of the rear hook 121 formed as described above is to penetrate the seal portion formed together with the casing rear hook 21 between the cooling medium space 126 and the intermediate chamber 18 as illustrated in FIG. 3 above. Also, the front hook slit 122s of the front hook 122 will penetrate the seal portion formed together with the casing front hook 22 between the cooling medium space 126 and the working fluid flow path 15.

Such defect of the seal portion will cause the cooling medium to flow into the working fluid side, which will reduce turbine efficiency. Therefore, the seal member is attached to ensure sealing performance against the defect of the seal portions caused by the slits, that is, the rear hook slits 121s and front hook slits 122s, penetrating these seal portions. The seal member connects part or all of the slit-formed range of the hook and the sealing surface of the casing to seal the space inside and outside the hook.

During assembly of the gas turbine 10, the seal member may be temporarily fixed by, for example, adhesives, and the like that volatilize at high temperature. Alternatively, the seal member may be fixed by point welding or the like.

A configuration of the seal member of each slit is explained below.

First, the seal members of the rear hook 121 are explained.

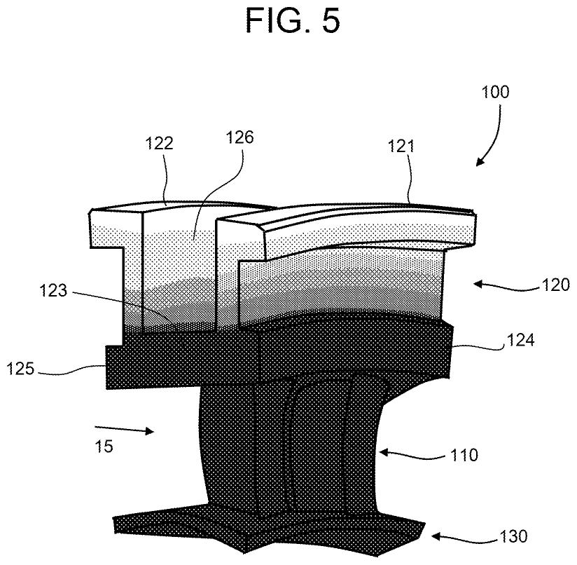

As illustrated in FIG. 2, FIG. 4, and FIG. 5, a plate-shaped first seal plate 121m and a plate-shaped second seal plate 121n are provided as the seal members of the rear hook slit 121s that is the slit of the rear hook 121. For the attachment of the plate-shaped first seal plate 121m and second seal plate 121n, a rectangular first insertion hole 121f and a rectangular second insertion hole 121h are each formed at the rear hook 121. The first seal plate 121m and the second seal plate 121n are made of a material having a coefficient of thermal expansion equal to or substantially the same as that of the material of the rear hook 121. As a result, the first insertion hole 121f and the second insertion hole 121h can be made to be minimum dimensions in width and thickness directions into which the first seal plate 121m and the second seal plate 121n can be inserted, respectively.

As illustrated in FIG. 4, the first seal plate 121m extends in the width direction (in the circumferential direction) on both sides of the rear hook slit 121s so as to block the rear hook slit 121s, and in a longitudinal direction, extends in the radial direction from the radially outer surface of the rear hook wall part 121a to a bottom portion at the radial inside, that is, to the same radial position as the plate-shaped part radially outer surface 123a.

As illustrated in FIG. 2, the second seal plate 121n extends in the axial direction almost parallel to the plate-shaped part radially outer surface 123a. That is, the second seal plate 121n extends in the width direction (in the circumferential direction) on both sides of the rear hook slit 121s so as to block the rear hook slit 121s in the width direction, and in the longitudinal direction, extends in the axial direction from the rear side surface of the rear hook protruding part 121c to a front side, that is, toward a direction of the cooling medium space 126, to a position that is in contact with the first seal plate 121m. A radial position of the second seal plate 121n is a position within a range where the rear side surface of the rear hook protruding part 121c and the rear sealing surface 21s (FIG. 3) at the radial outside of the casing rear hook 21 (FIG. 3) are in close contact to form the seal portion at a circumferential position where the rear hook slit 121s is not formed.

In FIG. 2 to FIG. 4, the case when a width of the second seal plate 121n is smaller than a width of the first seal plate 121m is illustrated as an example for convenience of illustration, but these may be the same as each other, or conversely, the width of the first seal plate 121m may be smaller than the width of the second seal plate 121n.

By providing the first seal plate 121m and the second seal plate 121n as described above, the entire second seal plate 121n and a radially inner portion of the first seal plate 121m from a position that is in contact with the second seal plate 121n range from the rear sealing surface 21s (FIG. 3) at the radial outside of the casing rear hook 21 to the plate-shaped part radially outer surface 123a, to separate the cooling medium space 126 from the intermediate chamber 18 as illustrated in FIG. 3. As a result, the sealing performance can be ensured for the defect of the seal portion due to the rear hook slit 121s penetrating the rear hook 121.

Next, the seal members of the front hook 122 will be explained.

As illustrated in FIG. 2 and FIG. 3, a rectangular plate-shaped first seal plate 122m and a plate-shaped second seal plate 122n are provided as the seal members for the front hook slit 122s that is the slit of the front hook 122. A first insertion hole 122f and a second insertion hole 122h are respectively formed at the front hook 122, for setting of the first seal plate 122m and the second seal plate 122n.

The first seal plate 122m and the second seal plate 122n are made of a material having a coefficient of thermal expansion equal to or substantially the same as that of a material of the front hook 122. As a result, the first insertion hole 122f and the second insertion hole 122h can be made to be minimum dimensions in width and thickness directions into which the first seal plate 122m and the second seal plate 122n can be inserted, respectively.

As illustrated in FIG. 2 and FIG. 3, the first seal plate 122m extends in the width direction (circumferential direction) on both sides of the front hook slit 122s to block the front hook slit 122s, and in the longitudinal direction, extends in the radial direction from the radially outer surface of the front hook wall part 122a to a bottom portion at the radial inside of the front hook slit 122s, that is, to the same radial position as the plate-shaped part radially outer surface 123a.

The second seal plate 122n has an angle against the plate-shaped part radially outer surface 123a and extends toward the radial outside as it goes rearward (downstream side). That is, the second seal plate 122n extends in the width direction (circumferential direction) on both sides of the front hook slit 122s to block the front hook slit 122s in the width direction, and in the longitudinal direction, extends from the radially inner surface of the front hook protruding part 122c to a position that is in contact with the first seal plate 122m. A position in the axial direction of the second seal plate 122n is a position within a range where the radially inner surface of the front hook protruding part 122c and the front sealing surface 22s (FIG. 3) of the casing front hook 22 (FIG. 3) are in close contact to form the seal portion at a circumferential position where the front hook slit 122s is not formed.

In FIG. 2 and other figures, the case when a width of the second seal plate 122n is smaller than a width of the first seal plate 122m is illustrated as an example for convenience of illustration, but these may be the same as each other or, conversely, the width of the first seal plate 122m may be smaller than the width of the second seal plate 122n.

By providing the first seal plate 122m and the second seal plate 122n as described above, the entire second seal plate 122n and a portion of the first seal plate 122m from a position that is in contact with the second seal plate 122n to the same radial position as the plate-shaped part radially outer surface 123a range from the casing front hook 22 to the plate-shaped part radially outer surface 123a, to separate the cooling medium space 126 from the working fluid flow path 15 as illustrated in FIG. 3. As a result, it is possible to ensure the sealing performance for the defect of the seal portion due to the front hook slit 122s penetrating the front hook 122.

Next, actions of the turbine stator blade 100 according to this embodiment will be explained.

FIG. 5 is a perspective view schematically illustrating an example of temperature distribution for explaining effects of the turbine stator blade 100 according to the first embodiment. In FIG. 5, the darker the color, the higher the temperature.

The blade effective part 110 placed in the working fluid flow path 15 and the inner circumferential sidewall 130 facing the working fluid flow path 15 are in the highest temperature region. Regarding the outer circumferential sidewall 120, the plate-shaped part 123, the rear protruding part 124, and the front protruding part 125 are in the highest temperature region.

The temperatures of the rear hook 121 and the front hook 122 of the outer circumferential sidewall 120 generally decrease toward the radial outside due to cooling effect of the cooling medium in the cooling medium space 126.

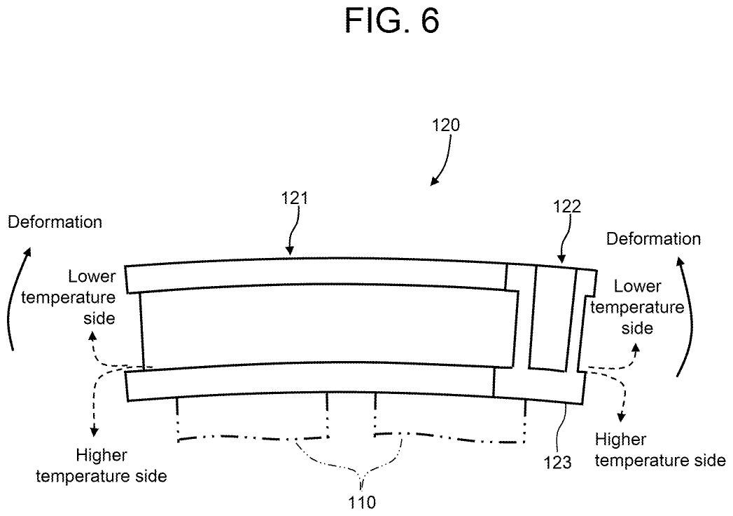

FIG. 6 is a perspective view schematically illustrating deformation due to the example of the temperature distribution for explaining the effect of the turbine stator blade according to the first embodiment. The slits are not illustrated in FIG. 6.

Since a radial inside portion of the outer circumferential sidewall 120 is in higher temperature and a radial outside portion is in lower temperature, the thermal expansion of the radial inside portion of the outer circumferential sidewall 120 is larger than that of the radial outside portion. As a result, a circumferential shape of the outer circumferential sidewall 120 deforms in a direction where the radial inside opens.

Due to the deformation of the outer circumferential sidewall 120 as illustrated in FIG. 6, a tensile load is generated, especially at a connection portion of the blade effective part 110 with the outer circumferential sidewall 120.

As for stress due to this load, tensile stress due to the tensile load is especially high at a rear edge of the blade effective part 110 because a cross-section of the blade effective part 110 is thinner at the rear edge. A fact that an axial position of the rear edge is close to an axial position of the rear hook 121 also contributes to this tendency.

A degree of deformation of the outer circumferential sidewall 120 depends on a relative relationship between stiffness G1 of the outer circumferential sidewall 120 and stiffness G2 of the blade effective part 110 and the inner circumferential sidewall 130. That is, when magnitude of the stiffness G1 is sufficiently large compared to the stiffness G2 and the stiffness G2 is negligible, the outer circumferential sidewall 120 will deform close to free deformation due to the thermal expansion. Conversely, when magnitude of the stiffness G2 is relatively large, the outer circumferential sidewall 120 will be constrained by the blade effective part 110 and inner circumferential sidewall 130, and its deformation amount will be reduced.

In the turbine stator blade 100 of this embodiment, the rear hook slit 121s of the rear hook 121 and the front hook slit 122s of the front hook 122 are formed at the outer circumferential sidewall 120. As a result, the stiffness G1 of the outer circumferential sidewall 120 decreases, and the deformation amount of the outer circumferential sidewall 120 decreases. As a result, an effect of lowering the tensile stress at the connection portion of the blade effective part 110 with the outer circumferential sidewall 120 can be obtained.

This effect will be shown by contrasting examples of deformed states of the outer circumferential sidewall without the slit and with the slit formed.

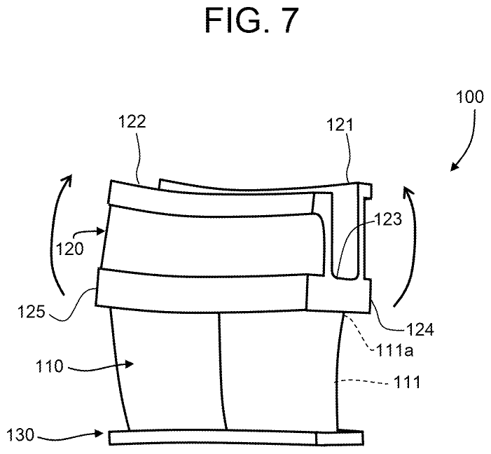

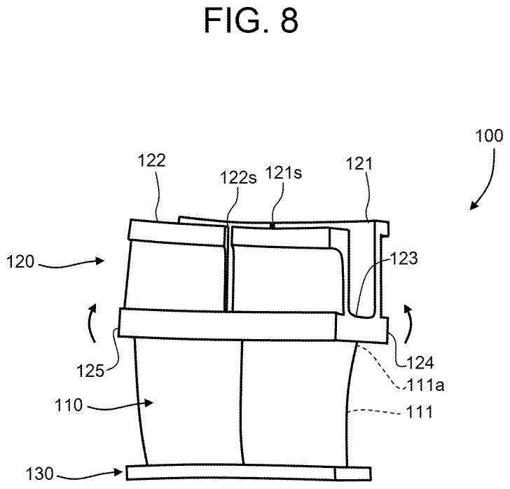

FIG. 7 is a perspective view schematically illustrating an example of the deformed state of the outer circumferential sidewall with no slit formed. FIG. 8 is a perspective view schematically illustrating an example of the deformed state of the outer circumferential sidewall 120 with the slit formed. FIG. 8 illustrates an example of the case when the rear hook 121 and the front hook 122 of the outer circumferential sidewall 120 have one rear hook slit 121s and one front hook slit 122s, respectively.

When the rear hook slit 121s and front hook slit 122s illustrated in FIG. 8 are formed, each stiffness of the rear hook 121 and the front hook 122 of the outer circumferential sidewall 120 decreases, which reduces the deformation in the direction where the radial inside of the outer circumferential sidewall 120 opens, compared to the case illustrated in FIG. 7 where these slits are not formed.

As a result, stress at a portion of high stress, such as near a blade effective part rear edge outer root part 111a, which is a connection portion of a blade effective part rear edge 111 of the blade effective part 110 with the outer circumferential sidewall 120, is particularly reduced.

As explained above, since the stress at the blade effective part rear edge outer root part 111a is high, the effect of the rear hook slit 121s formed at the rear hook 121 is particularly significant, and depending on a stress level, the slit may be formed only at the rear hook 121. Furthermore, depending on relative positions, shapes, and dimensions of the members in the turbine stator blade 100, the slit may be formed only at one of the rear hook and the front hook as long as the stress in the turbine stator blade 100 is effectively reduced.

As mentioned above, the turbine stator blade 100 according to this embodiment can reduce the stress near the connection portion of the blade effective part 110 with the outer circumferential sidewall 120 by forming the slit, thereby ensuring the soundness of the turbine stator blade 100. Besides, even after the formation of the slit, the sealing performance is ensured, which prevents the cooling medium from flowing into the working fluid side, thereby preventing a decrease in the turbine efficiency.

### Second Embodiment

This embodiment is a modification of the first embodiment.

The first embodiment is a case where, regarding the rear hook 121, the seal portion between the cooling medium space 126 and the intermediate chamber 18 is formed at the contact portion between the rear side surface of the rear hook protruding part 121c and the rear sealing surface 21s at the radial outside of the casing rear hook 21.

On the other hand, the second embodiment is a case where the seal portion between the cooling medium space 126 and the intermediate chamber 18 is formed at a contact portion between the radially outer surface of the rear hook protruding part 121c and a rear sealing surface 21v at the radial outside of the casing rear hook 21. The second embodiment can be applied to the case where such a state is formed.

In addition to the rear sealing surface 21v, the rear sealing surface 21s may be formed as in the first embodiment.

A force that pushes the turbine stator blade 100 to the downstream side due to a differential pressure in front and behind the turbine stator blade 100 may result in formation of the rear sealing surface 21s and deformation of the outer circumferential sidewall 120 such that the rear sealing surface 21s is formed.

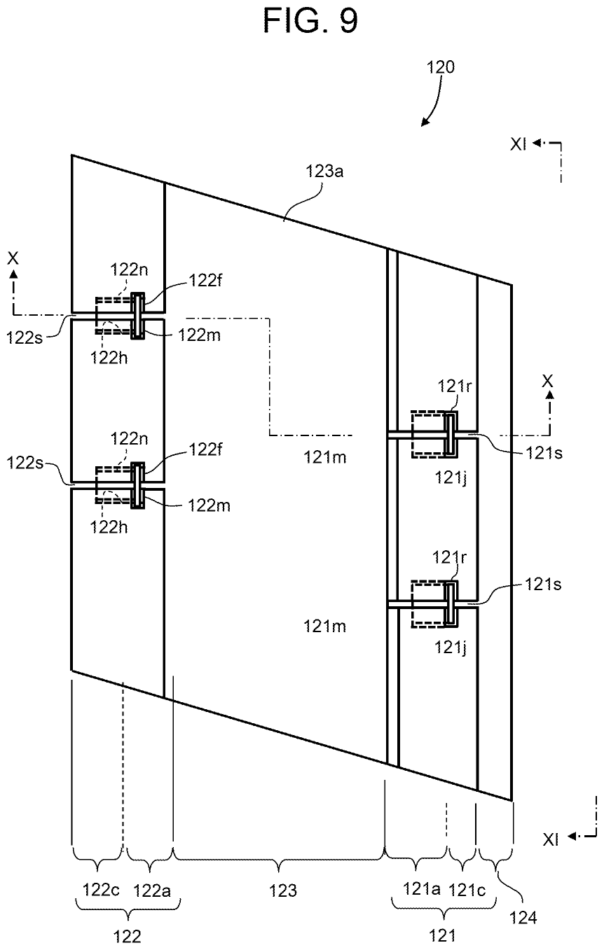

The second embodiment differs in a configuration of the seal portion of the rear hook slit 121s as the seal member and is otherwise the same as the first embodiment. The following description is made with reference to FIG. 9 to FIG. 11.

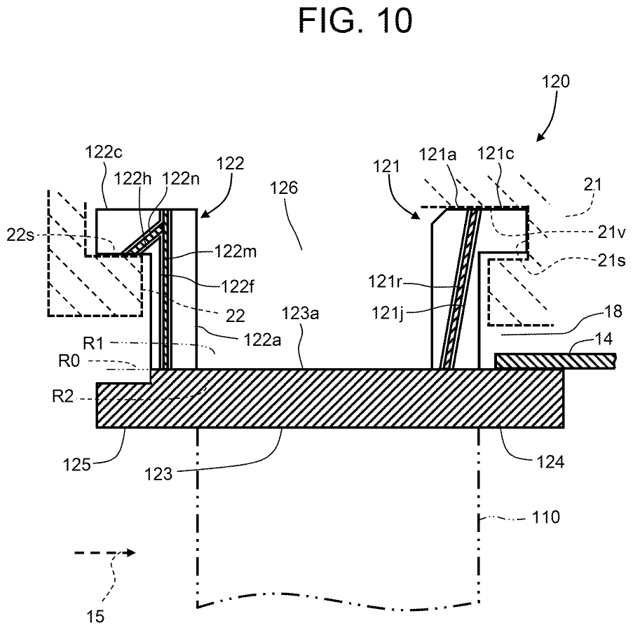

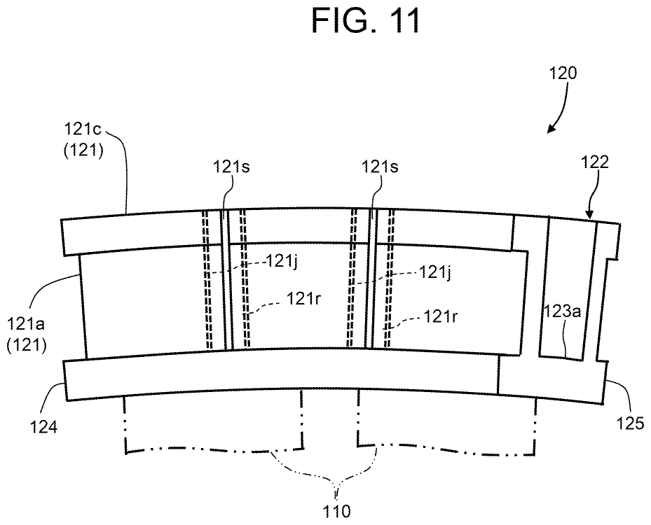

FIG. 9 is a plan view of the turbine stator blade 100 according to the second embodiment viewed from the radial outside, FIG. 10 is a sectional arrow view taken along a line X-X in FIG. 9, and FIG. 11 is a front arrow view taken along a line XI-XI in FIG. 9.

As the seal member in this embodiment, a single oblique seal plate 121r is provided instead of the first seal plate 121m and the second seal plate 121n in the first embodiment. For this purpose, an oblique insertion hole 121j is formed at the rear hook 121.

The oblique seal plate 121r extends in the width direction (circumferential direction) on both sides of the rear hook slit 121s to block the rear hook slit 121s in the width direction. In the longitudinal direction, as illustrated in FIG. 10, the oblique seal plate 121r extends radially inward and obliquely from a surface position of a portion where the radially outer surface of the rear hook protruding part 121c of the rear hook 121 faces the rear sealing surface 21v at the radial outside of the casing rear hook 21 to the bottom portion at the radial inside of the rear hook slit 121s, that is, to the same radial position as the radial position of the plate-shaped part radially outer surface 123a.

One end surface in the longitudinal direction of the oblique seal plate 121r may be finished parallel to a surface of a portion where the rear hook protruding part 121c of the rear hook 121 faces the rear sealing surface 21v (FIG. 10). The other end surface in the longitudinal direction of the oblique seal plate 121r may be finished parallel to the plate-shaped part radially outer surface 123a. This allows a contact area to be maximized at both ends in the longitudinal direction of the oblique seal plate 121r by surface contact, thereby improving the sealing performance.

When the outer circumferential sidewall 120 is shaped and dimensioned such that the oblique seal plate 121r can be provided to range from a portion of the rear hook protruding part 121c of the rear hook 121 that is in contact with the rear sealing surface 21s to the plate-shaped part radially outer surface 123a, the oblique seal plate 121r may be set in this manner.

As mentioned above, by providing only the oblique seal plate 121r, the oblique seal plate 121r ranges between the casing rear hook 21 and the plate-shaped part radially outer surface 123a, and the cooling medium space 126 can be separated from the intermediate chamber 18. As a result, the sealing performance can be ensured for the defect of the seal portion due to the rear hook slit 121s penetrating the rear hook 121.

### Other Embodiments

While certain embodiments have been described, these embodiments have been presented by way of example only, and are not intended to limit the scope of the inventions. Indeed, those embodiments may be embodied in a variety of other forms; furthermore, various omissions, substitutions, and changes in the form of the embodiments described herein may be made without departing from the spirit of the inventions. Embodiments and modifications thereof are included in the scope and gist of the invention as well as in the scope of the claims and their equivalents.

1. A turbine stator blade disposed in a working fluid flow path in a casing of a gas turbine, the turbine stator blade comprising:
a blade effective part disposed in the working fluid flow path;
an outer circumferential sidewall including a plate-shaped part that is connected to a radially outer end portion of the blade effective part, and hooks each extending radially outward and circumferentially from the plate-shaped part and having a tip engaged with the casing; and
an inner circumferential sidewall connected to a radially inner end portion of the blade effective part; wherein
at least one slit is formed at the hook to divide the hook in a circumferential direction, and
the hook has a seal member to seal the slit.

2. The turbine stator blade according to claim 1, wherein
the seal member connects part or all of a range of the hook where the slit is formed to a sealing surface of the casing to seal a space inside and outside the hook.

3. The turbine stator blade according to claim 1, wherein
the hooks include a front hook extending radially outward and circumferentially from an upstream end side of the plate-shaped part, and a rear hook extending radially outward and circumferentially from a downstream end side of the plate-shaped part,
the slit is formed at the rear hook, and
the seal members include:
a rear hook first seal plate in a plate shape extending on both sides of the slit to block the slit, in a width direction thereof, and extending in a radial direction from a radially outer surface of a rear hook wall part of the rear hook to a radial position of a bottom portion of the slit, in a longitudinal direction thereof; and
a rear hook second seal plate extending on both sides of the slit to block the slit, in the width direction thereof, and extending in an axial direction from a rear side surface of a rear hook protruding part of the rear hook toward an upstream direction to a position that is in contact with the rear hook first seal plate, in the longitudinal direction thereof.

4. The turbine stator blade according to claim 1, wherein
the hooks include a front hook extending radially outward and circumferentially from an upstream end side of the plate-shaped part, and a rear hook extending radially outward and circumferentially from a downstream end side of the plate-shaped part,
the slit is formed at the rear hook, and
the seal member includes an oblique seal plate extending radially inward and obliquely from a radially outer surface of the rear hook to a radial position of a bottom portion of the slit, and extending on both sides of the slit to block the slit in the width direction, in the width direction thereof.

5. The turbine stator blade according to claim 3, wherein
the slit is formed at the front hook, and
the seal members include:
a front hook first seal plate extending on both sides of the slit to block the slit, in the width direction thereof, and extending in the radial direction from a radially outer surface of the front hook to a radial position of a bottom portion of the slit, in the longitudinal direction thereof; and
a front hook second seal plate extending on both sides of the slit to block the slit in the width direction, in the width direction thereof, and extending from a radially inner surface of a protruding part formed at the front hook to a position that is in contact with the front hook first seal plate, in the longitudinal direction thereof.

6. The turbine stator blade according to claim 3, wherein
the position of the bottom portion of the slit is the same radial position as that of the radially outer surface of the plate-shaped part.

7. The turbine stator blade according to claim 1, wherein
the seal member has a coefficient of thermal expansion that is substantially equal to that of the outer circumferential sidewall.

8. The turbine stator blade according to claim 4, wherein
the slit is formed at the front hook, and
the seal members include:
a front hook first seal plate extending on both sides of the slit to block the slit, in the width direction thereof, and extending in the radial direction from a radially outer surface of the front hook to a radial position of a bottom portion of the slit, in the longitudinal direction thereof; and
a front hook second seal plate extending on both sides of the slit to block the slit in the width direction, in the width direction thereof, and extending from a radially inner surface of a protruding part formed at the front hook to a position that is in contact with the front hook first seal plate, in the longitudinal direction thereof.

9. The turbine stator blade according to claim 4, wherein
the position of the bottom portion of the slit is the same radial position as that of the radially outer surface of the plate-shaped part.
